(19) United States
(12) Patent Application Publication
(10) Pub. No.: US 2009/0216835 A1
(43) Pub. Date: Aug. 27, 2009

(54) GROUP MUTE

(76) Inventors: Mukul Jain, San Jose, CA (US); Joseph F. Khouri, San Jose, CA (US); Laurent Philonenko, San Francisco, CA (US); Shmuel Shaffer, Palo Alto, CA (US); Shantanu Sarkar, San Jose, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/035,593

(22) Filed: Feb. 22, 2008

(51) Int. Cl. G06F 15/16

(52) U.S. Cl. 709/204

(57) ABSTRACT

In an example embodiment, a technique that allows members of a group at multiple locations to have private conversations within members of the group while participating in a conference call. Group members are defined and divided into virtual conference rooms. When a group mute is requested, signals originating from members of the group are distributed to locations where group members are present, while all participants of the conference call, including the members of the muted group, receive un-muted media signals.

### TECHNICAL FIELD

The present disclosure relates generally to streaming media communication.

### BACKGROUND

In a large conference session involving multiple parties or teams, the ability to mute the phone is widely used today. It is frequently used when people dialing into a conference session from different physical meeting rooms want to hold a quick private conversation with participants present in the room without missing any of the conference communication. To hold a quick private conversation, one of the participants in the room presses mute button on the phone. This is a very useful feature used frequently when different teams dial in from different meeting rooms. For example, a Cisco team from San Jose dials into a conference bridge for conferencing with a group from Microsoft in Redwood City and Sun Microsystems in Santa Clara. When the Cisco team wants to hold a quick private conversation without missing the ongoing conference, a member of the Cisco team presses the mute button on the phone in the conference room.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an apparatus comprising a mixer configured for receiving a plurality of input media signals from a plurality of locations for a conference session. The mixer comprises logic configured to mix the input media signals and to distribute mixed input media signals to a plurality of outputs corresponding to the plurality of locations. The logic is configured to establish a virtual conference room for members of a group at a multiplicity of locations which are a subset of the plurality of locations. The logic is responsive to receiving a mute request from a member of the group to limit distribution of input media signals from members of the group to the virtual conference room. The logic is responsive to receiving a mute request from a member of the group to forward input media signals from all other users to the virtual conference room and to at least one location outside of the virtual conference room.

In accordance with an example embodiment, there is disclosed herein a system comprising a first mixer configured for receiving a plurality of input media signals from a first plurality of locations for a conference session, a second mixer configured for receiving a plurality of input media signals from a second plurality of locations for the conference session, and a communication link coupling the first mixer to the second mixer. The first mixer comprises logic configured to establish a virtual conference room; the logic mixes the input media signals from the first plurality of locations and input media signals received from the second mixer via the communication link to the first plurality of locations to distribute to the virtual conference room. The second mixer comprises logic configured to mix the input media signals from the second plurality of locations and input media received from the first mixer via the communication link to the first plurality of locations. The first mixer further comprises logic for implementing a group mute; the first mixer is configured to limit distribution of input media signals from the first plurality of locations to the virtual conference room while group mute is activated.

In accordance with an example embodiment, there is disclosed herein a method comprising creating a conference session having a plurality of locations, defining a virtual group, determining a subset of the plurality of locations where members of the virtual group are located, and receiving input media signals from the plurality of locations. The method further comprises mixing and distributing input media signals from the plurality of locations to the subset responsive to a group mute and mixing input media signals from the plurality of locations not in the subset of the plurality of locations and distributing the mixed input media signals from the plurality of locations not in the subset of the plurality of locations to the plurality of locations not in the subset of the plurality of locations responsive to a group mute.

### BRIEF DESCRIPTION OF THE DRAWINGS

The accompanying drawings incorporated herein and forming a part of the specification illustrate the example embodiments.

FIG. 1 illustrates an example of a mixer configured to implement a group mute in accordance with an example embodiment.

FIG. 2 illustrates an example of signal distribution from a mixer while group mute is in effect.

FIG. 3 illustrates an example of a mixer with a user interface and communication interface for implementing group mute in accordance with an example embodiment.

FIG. 4 illustrates an example embodiment employing a plurality of mixers wherein each mixer defines a virtual conference room.

FIG. 5 illustrates an example of a computer system for implementing an example embodiment.

FIG. 6 illustrates an example of a simple methodology for implementing group mute.

FIG. 7 illustrates an example of a detailed methodology for implementing group mute.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements.

Traditional ad hoc muting works when conference participants are in one meeting room; however, an example embodiment described herein allows a new feature called a group muting even when conference participants have not dialed in from one physical location. An aspect of the example embodiment is that it allows the members of the group to continue to talk to each other.

In accordance with an example embodiment, the conferencing system is capable of splitting a main conference session involving multiple sub teams into multiple virtual rooms, just like a physical conference room. In accordance with one embodiment, in order to set up these virtual rooms while scheduling a conference session, the conference organizer places multiple teams attending the meeting in different virtual conference rooms (VCRs). For example, an organizer may set up a meeting inviting people from projects A, B, and C. The meeting setup User Interface (UI) will provide an organizer feature to enter the invite list from project A as part of a virtual room A, project B as part of virtual room B, and so on. Accordingly, the system sends out meeting invitations and generates different meeting identifications “IDs” (one per virtual room) for the same conference session for each team. For example, team A can be assigned meeting ID-A and team B meeting ID-B and so on. Now when team A's members dial in, they use ID-A; when team B's members dial in, they use the meeting ID-B; and so on. As the participants join in the meeting, since they join using different meeting IDs, the system automatically identifies which virtual room to put them in while still joining a common conference session. Note that, although participants use different IDs, they are entering into the same conference room which is segmented into a plurality of VCRs.

Once a system is able to distribute attendees to their respective virtual rooms, a group mute feature is enabled per virtual room, which can be activated via various mechanisms, such as by pressing certain Dual Tone Multi Frequency (DTMF) digits or accessing the virtual room via an associated browser UI. For example, dialing a predefined code such as #5* in a conference room activates group mute, thus muting all participants of that virtual room to the main conference call. The main conference room is a superset of all the VCRs and can be heard by the virtual room participants.

If a conference participant from the virtual room A invokes the group mute feature, then the conference system will not mix incoming audio streams coming from any participant of virtual room A to the main conference; however, audio streams from main conference participants will continue to be mixed to virtual room A and thus delivered to virtual room A's participants. In one embodiment, when a group mute is invoked, the system uses the whisper feature to facilitate inner virtual room communication. In yet another embodiment, the system plays the main conference in one ear, for example the right ear, while using the left ear for virtual conference room (VCR) communications.

In one embodiment, policies can be defined to control who can activate the group mute feature and when. For instance, group mute can be limited to moderators or a meeting organizer, who can activate group muting using TUI (Telephone User Interface) and/or web UI. In another example embodiment, any user can activate the group mute feature, and it sends an approval request to moderator(s) and, upon successful approval, that virtual room is muted. In an example embodiment, any user in a given virtual room can mute that virtual room just like reaching out to press the mute button in the physical room. In accordance with one embodiment, when the group mute feature is invoked, the virtual room participants are notified that the group is muted by broadcasting (e.g. whispering) a announcement, such as participant X muted the virtual room, and/or a GUI associated to the conference session displays an appropriate group mute icon.

In another example embodiment, the different subgroups could belong to different organizations, such as Cisco and Microsoft. In this case, the service provider can either host the entire meeting as a single meeting with two subgroups (as described herein supra) or there can be two separate enterprise meeting rooms that are linked together. If two (or more) separate enterprise meeting rooms are linked together, such as a Cisco meeting room and a Microsoft meeting room, they can be linked together over a peer-to-peer signaling and media link. This allows for active speaker information and roster information to be exchanged, as well as Real-Time Protocol (RTP) streams for candidate active speakers. This architecture allows the Cisco group (or the Microsoft group, for that matter) to mute themselves from the main conference and discuss internal details.

In an example embodiment, VCRs could be defined based on other logical separation criterion such as company A's participants, e.g., all participants dialing in from Microsoft or Sun Microsystems and Cisco, etc. Accordingly, all internal callers are part of one VCR. Also, in addition, VCRs can apply different security and recording policies than those of the main conference room. For example, recording can be limited to specific VCRs and/or specific VCRs can be excluded from recording.

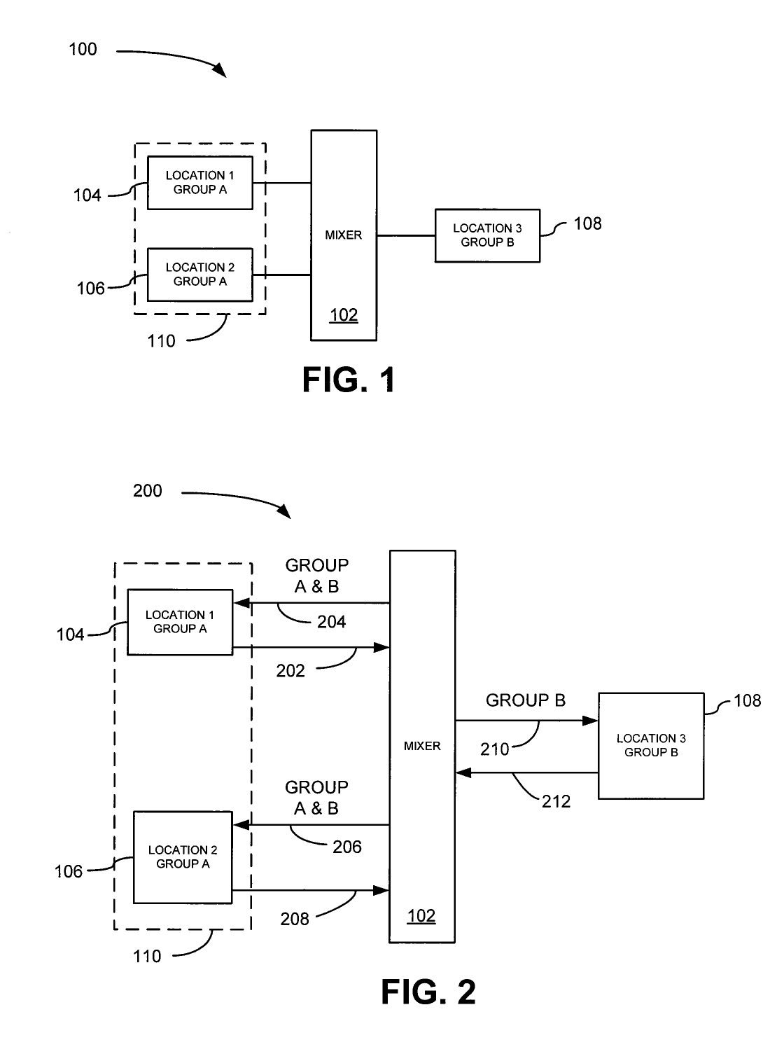

FIG. 1 illustrates an example of a system 100 configured to implement a group mute in accordance with an example embodiment. In the illustrated embodiment, mixer 102 is configured to implement a conference session comprising first location (Location 1) 104 with a user belongs to a first group (Group A), a second location (Location 2) 106 with a user that belongs to the first group (Group A), and a third location (Location 3) 108. During the conference session, mixer 102 is configured to receive media signals from the first location 104, the second location 106, and the third location 108. Mixer 102 comprises logic configured to mix the input media signals and distribute mixed input media signals to a plurality of outputs (which may also be sharing the same connection as the inputs) corresponding to the plurality of locations. A source of a signal does not receive its own signal back. For example, in un-muted mode, mixer 102 provides first location 104 with mixed media signals from second location 106 and third location 108, while second location 106 is provided with mixed media signals from first location 104 and third location 108, and third location 108 is provided with mixed media signals from first location 104 and second location 106. “Logic,” as used herein, includes but is not limited to hardware, firmware, software, and/or combinations of each to perform a function(s) or an action(s) and/or to cause a function or action from another component. For example, based on a desired application or need, logic may include a software controlled microprocessor, discrete logic such as an application specific integrated circuit (ASIC), a programmable/programmed logic device, a memory device containing instructions, or the like, or combinational logic embodied in hardware. Logic may also be fully embodied as software. As used herein, media signals include but are not limited to RTP signals, audio signals, video signals, text, data, and/or any other signals exchanged between endpoints but does not include control messages used in performing call setup functions.

The logic in mixer 102 is configured to establish a virtual conference room 110 for members of a group (Group A as illustrated) at a multiplicity of locations (such as first location 104 and second location 106), which are a subset of the plurality of locations. In response to a group mute request from a member of virtual conference room 110, the logic in mixer 102 limits distribution of input media signals from members of the virtual conference room 110 to the virtual conference room 110. Input media signals from non-group members, for example at third location 108, are distributed to virtual conference room 110. Therefore, in the illustrated example, when virtual conference room 110 is muted, mixer 102 provides first location 104 with mixed media signals from second location 106 and third location 108, while second location 106 would be provided with mixed media signals from first location 104 and third location 108, and third location 108 would not receive any signals from first location 104 and second location 106. If there were other participants to the conference session that did not belong to virtual conference room 110 (not shown), the mixed media signals from the other participants would be provided to third location 108 and to participants in virtual conference room 110.

Referring to FIG. 2, with continued reference to FIG. 1, there is illustrated a signal diagram 200 in accordance with an example embodiment. Signal diagram 200 illustrates an example of how signals are distributed by mixer 102 when a member of Group A in virtual conference room 110 requests a group mute. Mixer 102 receives input signal 202 from first location 104, input signal 208 from second location 106 and input signal 212 from third location 108. Logic in mixer 102 mixes and distributes input media signals 202, 208, 212 so that only members of virtual conference room 110 receive input media signals 202, 208 from members of virtual conference room 110 while group mute is in effect for Group A.

For example, while group mute for Group A is in effect, signal 204 to first location 104 comprises media signal 208 from Group A and signal 212 from Group B (third location 108). Signal 206 to second location 106 comprises media signal 202 from Group A and signal 212 from Group B. Signal 210 does not include media signals 202, 208 from Group A. When group mute is not in effect for Group A, location 108 receives media signals 202 and 208.

Mixer 102 should not be construed as limited to the number of signals illustrated herein, as this number was merely selected for ease of illustration of the example embodiment, as mixer 102 is suitably configured to receive signals from any physically realizable number of locations. Likewise, the number of groups and the size of the group were selected for ease of illustration, and the example embodiment should not be construed as limited to the number illustrated. The size and number of groups can be any physically realizable size or number.

Mixer 102 is capable of distributing any type of media stream. For example, mixer 102 may send and receive RTP streams. The media streams may suitably comprise an audio stream and/or a video stream. Mixer 102 may further comprise a plurality of mixers. A single mixer was merely chosen for ease of illustration, as members of a group may be coupled to more than one mixer. Separate mixers may also be employed for different types of media; for example, a first mixer may mix and distribute audio streams while a second mixer mixes and distributes video streams. In yet another example embodiment, mixer 102 facilitates web sharing amongst members of the conference rooms such as, for example, a private chat room. While the remainder of this specification refers to audio mixing, those who are skilled in the art should recognize that the example embodiments described herein are equally applicable to any media and/or combination of multimedia.

In accordance with example embodiments, logic in mixer 102 may employ one or more techniques to enable members of virtual conference room 110 to distinguish between group member signals 202, 208 and non-group member signals 212 while group mute is in effect. For example, logic in mixer 102 can be configured to distribute signals from members of the first group to the virtual conference room at a first level and to distribute signals from all other users at a second level to the virtual conference room. For example, group member signals may be louder. As another example, logic in mixer 102 can be configured to distribute signals from members of the virtual conference room on a first channel and to distribute signals from all other users to the virtual conference room on a second channel, such as right and left channels of an audio system.

In accordance with an example embodiment, a selected member of the group can be designated a moderator for the group. Logic in mixer 102 can be configured to limit group mute requests to the moderator. In another example embodiment, when a member of a group who is not the moderator requests a group mute, the request can be forwarded to the moderator. The moderator can approve the request, such as by activating group mute.

In accordance with an example embodiment, logic in mixer 102 can send an announcement signal to the virtual conference room 110 responsive to the group mute request. The announcement can inform the members of the group that virtual conference room 110 is muted.

In an example embodiment, the signals are not mixed at the mixer but at the endpoints. For example, un-mixed signals are provided to the endpoints, e.g. first location 104, second location 106, and third location 108, by mixer 102. Mixer 102 provides data (instructions) to the endpoints about which media signals should be mixed and how to mix them. For example, in normal operating mode, mixer 102 passes instructions to first location 104 to mix signals from second location 104 and third location 106 but, while in group mute mode, mixer 102 instructs first location 104 to mix media signals from location 106 and third location 108 so that media signals from first location 106 are at a different setting (for example, higher volume) than media signals from third location 108. During group mute, media signals from first location 104 and second location 106 are not provided to third location 108.

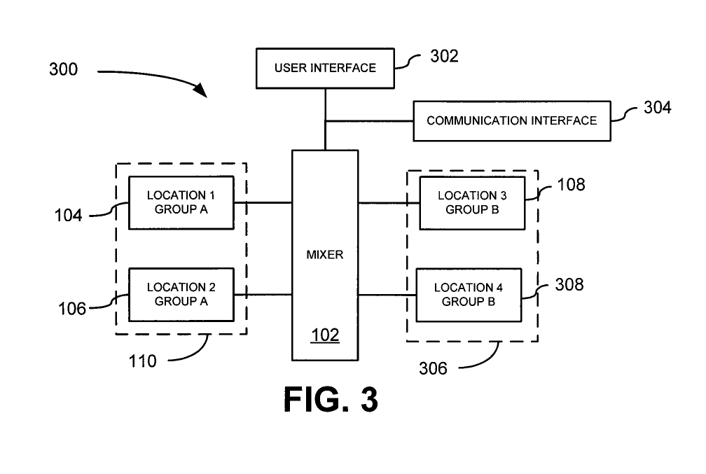

Referring to FIG. 3 with continued reference to FIG. 1, there is illustrated an example embodiment 300 illustrating a mixer 102 with a user interface 302 and a communication interface 304. In addition, example embodiment 300 illustrates a second virtual conference room 306 comprising third location 108 and a fourth location (Location 4) 308.

User interface 302 is in data communication with the mixer 102. User interface 302 comprises logic configured to receive data to establish the conference session and data indicative of the members of a group, such as Group A belonging to virtual conference room 110 or Group B belonging to virtual conference room 306. Communications interface 304 is in data communication with mixer 102 and the user interface 302.

User interface 302 comprises logic configured to establish a meeting identification for the conference session and a separate meeting identification for the virtual conference room (such as virtual conference room 110 or 306).

Communication interface 304 distributes the separate meeting identification for the virtual conference room to group members (for example locations 104, 106 for virtual conference room 110 and/or locations 108, 308 for virtual conference room 306). For example, if one subset of users are assigned, a separate virtual conference room (VCR) is defined for the one subset of users (by default, all users are assigned to a general VCR encompassing all users that is assigned a general conference session identifier such that the VCR for the one subset of users is actually a second VCR), and only members of that virtual conference room receive a separate identifier, while all other users receive a general conference session identifier. As an example, if only virtual conference room 110 is defined, then locations 104, 106 receive a meeting identifier for virtual conference room 110, which is actually a second VCR, while locations 108, 308 receive a meeting identifier for the conference session, which by default is a first VCR.

In an example embodiment, user interface 302 may be implemented in a web-based interface. For example, an organizer of the conference session can use a web browser to access the user interface via communication interface 304. User interface 302 enables an organizer to create groupings (such as virtual conference rooms). In an example embodiment, user interface 302 is configured to receive data to organize a group based on a user profile of invitees to the conference session. In another example embodiment, user interface 302 is configured to receive data to organize the group based on user entered data. For example, the meeting organizer can assign groups.

In an example embodiment, groupings can be dynamically created, for example, while the call is in progress. User interface 302 can be configured to receive a request from a member of the group (or from a session participant to create the group) to invite a non-member into the group. The invitation to join the group can be communicated via communication interface 304 to the non-member.

In an example embodiment, a meeting organizer uses user interface 302 to create a conference session, create groups (virtual conference rooms), and to assign participants of the conference session to the groups. Each group can be assigned a separate meeting identifier, which is communicated to participants assigned to the group. Communication interface 304 communicates the meeting identifiers or any other pertinent information to the participants. For example, communication interface 304 can be suitably configured to generate an email to participants to the conference session. The email can include a meeting identifier. Members of a group can be assigned a separate identifier, while meeting participants not belonging to a group can be assigned a general meeting identifier. If there is a plurality of groups, each group can be assigned its own unique meeting identifier.

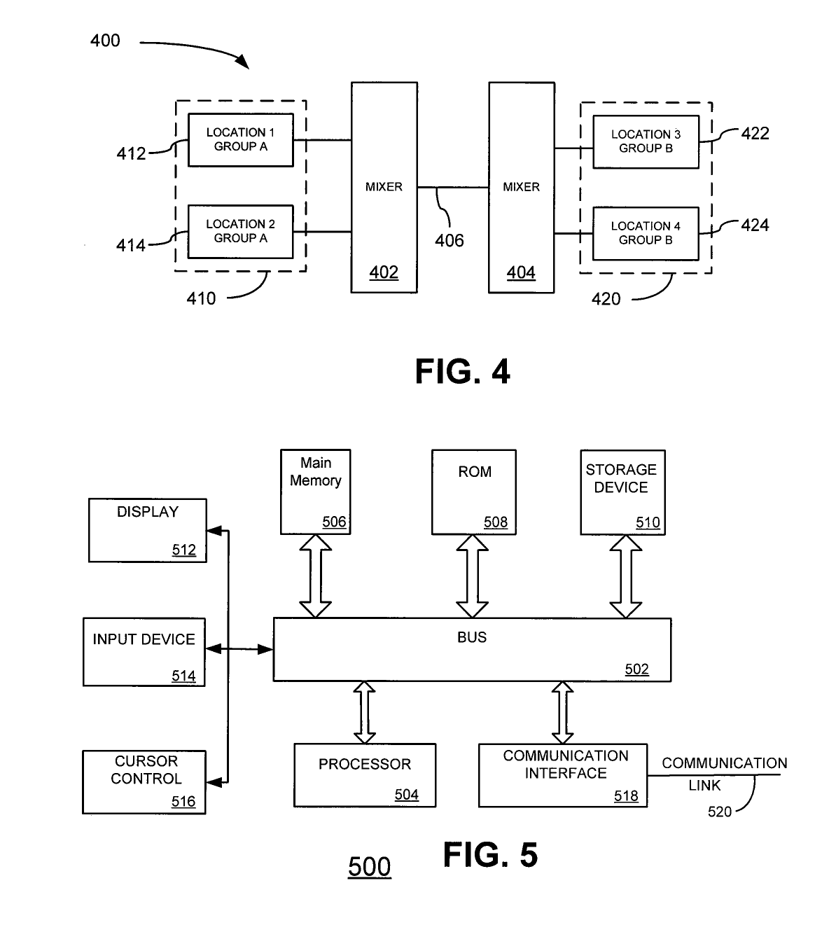

FIG. 4 illustrates an example embodiment 400 employing a plurality of mixers 402, 404. Each mixer 402, 404 has its own virtual conference rooms, e.g., 410, 420 respectively. Embodiment 400 may be employed in situations where participants belong to multiple organizations. For example, mixer 402 may belong to a first organization, while mixer 404 may belong to a second organization. Communication link 406 is established between mixers 402, 404. Communication link 406 is suitably any wired, wireless, or combination of wired and wireless links that is capable of handling the media stream (for example audio, visual, audiovisual, etc.) appropriate for the conference session.

In embodiment 400, virtual conference rooms are established on each mixer 402, 404 separately. For example, virtual conference room 410 is organized on mixer 402 and comprises first location (Location 1) 412 and second location (Location 2) 414, both of which belong to the first organization (Group A). Virtual conference room 420 is organized on mixer 404 and comprises third location (Location 3) 422 and fourth location (Location 4) 424, both of which belong to the second organization (Group B). When a user of the first group (Group A) activates group mute (for example, by dialing a specific code or pressing a designated button on a phone), mixer 402 mutes media signals to the second group (Group B). While the first group is muted, mixer 402 mixes media signals from locations 412, 414 and signals received on communication link 406 and distributes them to virtual conference room 410 (which includes first location 412 and second location 414); however, signals from locations 412, 414 are not distributed over communication link 406. Similarly, while the second group is muted, mixer 404 mixes media signals from third location 422, fourth location 424, and signals received on communication link 406 and distributes the mixed media signals to virtual conference room 420 (which includes third location 422 and fourth location 424); however, media signals from virtual conference room 420 are not distributed over communication link 406.

Although mixers 402, 404 are illustrated as having one virtual conference room each, those skilled in the art should readily appreciate that mixers 402, 404 can be configured to support a plurality of virtual conference rooms. Example embodiment 400 shows one virtual conference room 410, 420 on mixers 402, 404 respectively for ease of illustration. Thus, mixers 402, 404 should not be construed as limited to one virtual conference room per mixer.

In an example embodiment, the signals are not mixed at the mixers but at the endpoints. For example, un-mixed signals are provided to the endpoints, e.g. first location 412 and second location 414 by mixer 402, and third location 422 and fourth location 424 by mixer 404. Mixers 402, 404 provide data (instructions) to the endpoints about which media signals should be mixed and how to mix them. For example, in normal operating mode, mixer 402 passes instructions to first location 412 to mix signals from second location 414, third location 422, and fourth location 424 but, while Group A is in group mute mode, mixer 402 instructs first location 412 to mix media signals from second location 414, third location 422, and fourth location 424 such that media signals from second location 414 are at a different setting (for example, higher volume) than media signals from third location 422 and fourth location 424. As another example, while Group A is in group mute, although media signals from first location 412 and second location 414 are provided to third location 422 and fourth location 424, mixer 404 instructs third location 422 and fourth location 424 to ignore the media signals from first location 412 and second location 424.

Also those skilled in the art should readily appreciate that, while FIG. 4 describes two virtual conference rooms each one residing in a separate mixer (402, and 404), this is done only for illustration and should not be viewed as limiting the example embodiments described herein. The example embodiments also include a topology, wherein members of a VCR can join a conference using a plurality of mixers and do not need to be confined to joining using the same mixer.

FIG. 5 is a block diagram that illustrates a computer system 500 upon which an example embodiment may be implemented. For example, computer system 500 can be employed for implementing mixer 102 (FIGS. 1, 2 and 3) and/or mixers 402, 404 (FIG. 4).

Computer system 500 includes a bus 502 or other communication mechanism for communicating information and a processor 504 coupled with bus 502 for processing information. Processor 504 may include also a DSP (Digital Signal Processor) for mixing and processing the media. Computer system 500 also includes a main memory 506, such as random access memory (RAM) or other dynamic storage device coupled to bus 502 for storing information and instructions to be executed by processor 504. Main memory 506 also may be used for storing a temporary variable or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT) or liquid crystal display (LCD), for displaying information to a computer user. An input device 514, such as a keyboard including alphanumeric and other keys, is coupled to bus 502 for communicating information and command selections to processor 504. Another type of user input device is cursor control 516, such as a mouse, a trackball, or cursor direction keys, for communicating direction information and command selections to processor 504 and for controlling cursor movement on display 512. This input device typically has two degrees of freedom in two axes, a first axis (e.g. x) and a second axis (e.g. y), that allow the device to specify positions in a plane.

An aspect of the example embodiment is related to the use of computer system 500 for group mute. According to an example embodiment, group mute is provided by computer system 500 in response to processor 504 executing one or more sequences of one or more instructions contained in main memory 506. Such instructions may be read into main memory 506 from another computer-readable medium, such as storage device 510. Execution of the sequence of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement an example embodiment. Thus, embodiments described herein are not limited to any specific combination of hardware circuitry and software.

The term “computer-readable medium,” as used herein, refers to any medium that participates in providing instructions to processor 504 for execution. Such a medium may take many forms, including but not limited to non-volatile media, volatile media, and transmission media. Non-volatile media include, for example, optical or magnetic disks such as storage device 510. Volatile media include dynamic memory such as main memory 506. Transmission media include coaxial cables, copper wire, and fiber optics, including the wires that comprise bus 502. Common forms of computer-readable media include, for example, floppy disk, a flexible disk, hard disk, magnetic cards, paper tape, any other physical medium with patterns of holes, a RAM, a PROM, an EPROM, a FLASHPROM, CD, DVD, any other memory chip or cartridge, or any other medium from which a computer can read.

Various forms of computer-readable media may be involved in carrying one or more sequences of one or more instructions to processor 504 for execution. For example, the instructions initially may be borne on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector coupled to bus 502 can receive the data carried in the infrared signal and place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling computer system 500 to a communication link 520. For example, communication link 520 can be coupled to a local area network (LAN), wide area network (WAN), the Internet, and/or a telephone network.

For example, communication interface 518 may be a local area network (LAN) card to provide a data communication connection to a compatible LAN. As another example, communication interface 518 may be an integrated services digital network (ISDN) card or a modem to provide a data communication connection to a corresponding type of telephone line. Wireless links may also be implemented. In any such implementation, communication interface 518 sends and receives electrical, electromagnetic, or optical signals that carry digital data streams representing various types of information.

Computer system 500 can send messages and receive data, including program codes, through the network(s), communication link 520, and communication interface 518. In accordance with an example embodiment, one such downloaded application provides for Group Mute as described herein.

The received code may be executed by processor 504 as it is received and/or stored in storage device 510 or other non-volatile storage for later execution. Computer system 500 may employ additional communication interfaces (not shown) to communicate with multiple networks.

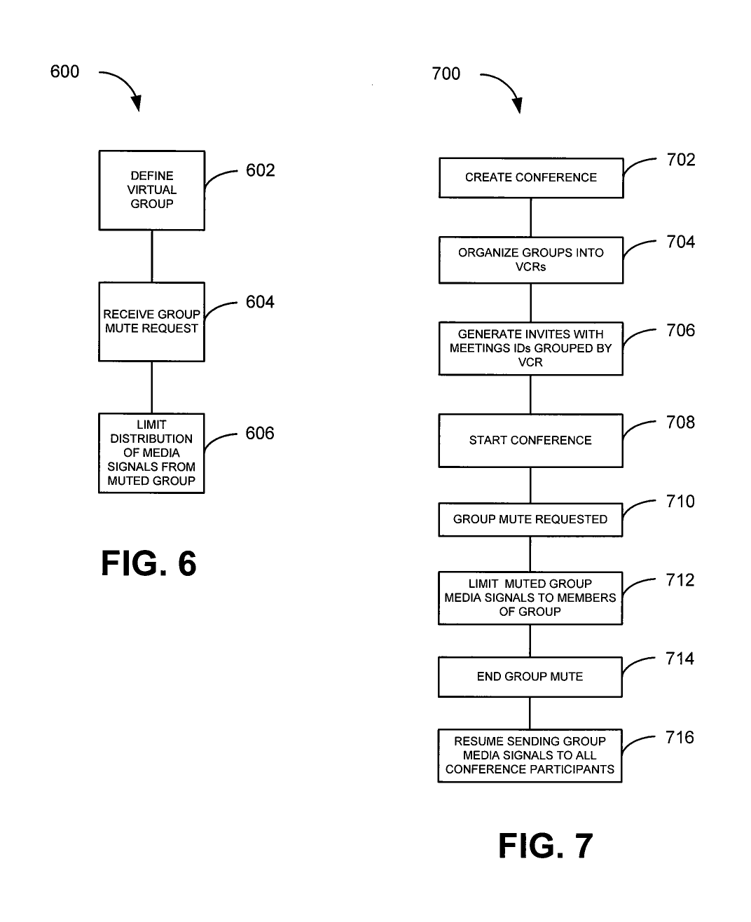

In view of the foregoing structural and functional features described above, methodologies in accordance with example embodiments will be better appreciated with reference to FIGS. 6 and 7. While, for purposes of simplicity of explanation, the methodologies of FIGS. 6 and 7 are shown and described as executing serially, it is to be understood and appreciated that the example embodiment is not limited by the illustrated order, as some aspects could occur in different orders and/or concurrently with other aspects from those shown and described herein. Moreover, not all illustrated features may be required to implement a methodology in accordance with an aspect of the example embodiment. The methodologies described herein are suitably adapted to be implemented in hardware, software, or a combination thereof.

FIG. 6 illustrates an example of a simple methodology 600 for implementing group mute. The group mute in methodology 600 may include group members that span a plurality of locations, as described herein.

At 602, a virtual group is defined. The groups may be established statically and/or dynamically. For example, a moderator or user setting up a conference session can establish one or more groups participating in the conference session. Groups also may be established while the conference session is in progress.

The grouping of participants can be by any desired criterion. For example, groups can be organized by user profiles, organization (e.g. Cisco employees or an organizational unit, such as a department within an organization), or regions (e.g. West coast, East coast, San Jose, Cleveland, etc.). Each group forms a virtual conference room. The virtual conference room comprises a group attending the conference session from a multiplicity of locations. It should be noted that, by default, all of the users are in one group. If a user establishes a private VCR, by default, all of the users who are not in this specific VCR are considered to be in a second VCR group.

In an example embodiment, after the groups are defined, invitations to attend the conference are generated. In an example embodiment, invitations are emailed to conference participants. In an example embodiment, each virtual conference room is assigned a unique meeting ID. Thus, a participant may receive a meeting ID for the conference session or a unique meeting ID for a virtual conference room associated with the conference session.

In another example embodiment, participants are assigned a login. A conference participant can be associated with the appropriate virtual conference room, if assigned to one, upon a successful login.

The system hosting the conference session determines from connection information the virtual conference rooms associated with the participants. For example, a meeting ID can be used to associate an input port with a virtual conference room. It is also possible that a participant may not be associated with any private virtual conference rooms, in which case the participant would be assigned a general conference session ID. As another example, a user can login and the user profile can be accessed to associate the input port the user is logging in from with the appropriate virtual conference room. Once the conference begins, media signals from a plurality of locations are received, mixed, and distributed to all participants of the conference session, except when a group mute is in effect for one or more groups associated with the conference session. If groups are created dynamically while the conference is in process, logic in the system hosting the conference session maintains an updated list of group memberships, which may change while the conference session is in progress.

At 604, a participant requests a group mute. In an example embodiment, any member of the group can request the group mute. In another example embodiment, a moderator can be assigned, and group mute requests can be limited to the moderator. If another user requests a group mute, the request can be forwarded to the moderator for approval. A member of the group can request the group mute by dialing a predefined DTMF number, pressing a predefined button on a local telephone console, or use a web browser to communicate a group mute request.

At 606, media signals from members of the muted group are limited to members of the group while group muting is in effect. The mixing logic receiving the media signals from members of the group limits distribution to the group members via the virtual conference room while group mute is in effect. The virtual conference room may span a multiplicity of locations. Media signals from meeting participants that are not members of the group are distributed to all meeting participants, except media signals belonging to another group that is muted, which will be limited to that group.

In an example embodiment, an announcement is sent to locations in the virtual conference room when group mute is requested. In an example embodiment, members of the group may receive media signals from other members of the group at a first setting, such as a first volume level, while media signals from participants not belonging to the group are received at a second setting, such as a second volume level. For example, media signals from members of the group are received at normal volume, while media signals from non-members are muted (whispered).

In an example embodiment, media signals can be distributed on different channels. For example, for a stereo system, group media signals can be received on the right channel while non-group member media signals can be received on the left channel or vice versa.

FIG. 7 illustrates an example of a detailed methodology 700 for implementing group mute. At 702, a conference session is created. A moderator or user setting up a conference session can specify parameters such as date and time of call, participants, etc. The participants for the conference session may be situated in a plurality of locations. The conference session may suitably comprise any suitable media stream such as an RTP stream, an audio signal, a video signal, or a combination of audiovisual signals.

At 704, meeting participants can be organized into one or more groups. The grouping of participants can be by any desired criterion. For example, groups can be organized by user profiles, organization (e.g. Cisco employees or an organizational unit, such as a department within an organization), or regions (e.g. West coast, East coast, San Jose, Cleveland, etc.). Each group forms a virtual conference room. The virtual conference room may suitably comprise a multiplicity of locations.

At 706, invitations to attend the conference are generated. In an example embodiment, invitations are emailed to conference participants. In an example embodiment, each virtual conference room is assigned a unique meeting ID. Thus, a participant may receive a meeting ID for the conference session or a unique meeting ID for a virtual conference room associated with the conference session.

In another example embodiment, participants are assigned a login. A conference participant can be associated with the appropriate virtual conference room, if assigned to one, upon a successful login.

At 708, the conference session begins. The system hosting the conference session determines from connection information the virtual conference rooms associated with the participants. For example, a meeting ID can be used to associate an input port with a virtual conference room. It is also possible a participant may not be associated with any virtual conference rooms, in which case the participant would be assigned a general conference session ID. As another example, a user can login and the user profile can be accessed to associate the input port the user is logging in from with the appropriate virtual conference room. Once the conference begins, input media signals from a plurality of locations are received, mixed, and distributed to all participants of the conference session, except when a group mute is in effect for one or more groups associated with the conference session.

At 710, a participant requests a group mute. In an example embodiment, any member of the group can request the group mute. In another example embodiment, a moderator can be assigned, and group mute requests can be limited to the moderator. If another user requests a group mute, the request can be forwarded to the moderator for approval. A member of the group can request the group mute by dialing a predefined DTMF number, pressing a predefined button on a local telephone console, or use a web browser to communicate a group mute request.

At 712, signals from the group are muted while the group mute is in effect. The mixing equipment receiving the input media signals from members of the group limits distribution to the group members via the virtual conference room while group mute is in effect. The virtual conference room may span a multiplicity of locations. While the group mute is in effect, input media signals from members of the group are muted, e.g. they are not distributed to locations that are not in the virtual conference room. Input media signals from meeting participants that are not members of the group are distributed to all meeting participants, except input media signals belonging to another group that is muted, which will be limited to that group.

In an example embodiment, an announcement is sent to locations in the virtual conference room when group mute is requested. In an example embodiment, members of the group may receive media signals from other members of the group at a first setting, such as volume level, while media signals from participants not belonging to the group are received at a second setting, such as volume level. For example, media signals from members of the group are received at normal volume, while signals from non-members are muted (whispered).

In an example embodiment, media signals can be distributed on different channels. For example, for a stereo system, group media signals can be received on the right channel while non-group member media signals can be received on the left channel or vice versa.

At 714, the group mute ends. In an example embodiment, a member of the group may dial a predefined DTMF number to end the group mute. In another example embodiment, a member of the group activates or presses a predefined button to indicate the group mute is done. In an example embodiment, an announcement is sent to locations in the virtual conference room informing the group members that group mute has ended.

At 716, input media signals from members of the group are sent to all meeting participants. The media signals are no longer limited to members of the group associated with the virtual conference room. Additional group mutes may be requested. Steps 710, 712, 714, 716 can be repeated any number of times during the conference session.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications, and variations that fall within the spirit and scope of the appended claims interpreted in accordance with the breadth to which they are fairly, legally, and equitably entitled.

1. An apparatus, comprising:
a mixer configured for receiving a plurality of input media signals from a plurality of locations for a conference session, the mixer comprising logic configured to mix the input media signals and distribute mixed input media signals to a plurality of outputs corresponding to the plurality of locations;
wherein the logic is configured to establish a virtual conference room for members of a group at a multiplicity of locations which are a subset of the plurality of locations; and
wherein the logic is responsive to receiving a group mute request from a member of the group to limit distribution of input media signals from members of the group to the virtual conference room.

2. The apparatus of claim 1, further comprising:
a user interface in communication with the mixer, the user interface comprising logic configured to receive data to establish the conference session and data indicative of the members of the group;
a communications interface in communication with the mixer and the user interface;
wherein the user interface logic is configured to establish a meeting identification for the conference session and a separate meeting identification for the virtual conference room;
wherein the communication interface distributes the separate meeting identification for the virtual conference room to group members; and
wherein the communication interface is configured to distribute the identification for the conference session to users that are not members of the group.

3. The apparatus of claim 2, wherein the user interface is configured to receive data to organize the group based on a user profile of invitees to the conference session.

4. The apparatus of claim 2, wherein the user interface is configured to receive data to organize the group based on a user entered data.

5. The apparatus of claim 2, wherein the user interface is configured to receive a request from a member of the group to invite a non-member into the group; and
wherein the communication interface is responsive to the request to communicate an invitation to the non-member to join the group.

6. The apparatus of claim 1, wherein the input media signals comprise an audio stream.

7. The apparatus of claim 1, wherein the input media signals comprise a video stream.

8. The apparatus of claim 1, wherein the mixer comprises a plurality of mixers.

9. The apparatus of claim 8, wherein the plurality of mixers comprises a first mixer for mixing audio input media signals and a second mixer for mixing video input media signals.

10. The apparatus of claim 1, wherein the mixer is further responsive to receiving the group mute request to distribute media signals from members of the group to the virtual conference room at a first setting and to distribute media signals from all other users to the virtual conference room at a second setting.

11. The apparatus of claim 1, wherein the mixer is further responsive to receiving the group mute request to distribute media signals from members of the group to the virtual conference room on a first channel and to distribute media signals from all other users to the virtual conference room on a second channel.

12. The apparatus of claim 1, wherein a selected member of the group is designated a moderator for the group, and wherein the group mute request is limited to the moderator.

13. The apparatus of claim 12, wherein the mixer is configured to direct a group mute request from a member of a group that is not a moderator to the moderator for approval.

14. The apparatus of claim 1, wherein the mixer sends an announcement signal to the virtual conference room responsive to the group mute request informing the members of the group that the virtual conference room is muted.

15. A system, comprising:
a first mixer configured for receiving a plurality of input media signals from a first plurality of locations for a conference session;
a second mixer configured for receiving a plurality of input media signals from a second plurality of locations for the conference session;
a communication link coupling the first mixer to the second mixer;
wherein the first mixer comprises logic configured to establish a virtual conference room, the logic mixing the input media signals from the first plurality of locations and input media signals received from the second mixer via the communication link to the first plurality of locations to distribute to the virtual conference room;
wherein the second mixer comprises logic configured to mix the input media signals from the second plurality of locations and input media signals received from the first mixer via the communication link to the first plurality of locations;
wherein the first mixer further comprises logic for implementing a group mute, the first mixer being configured to limit distribution of input media signals from the first plurality of locations to the virtual conference room while group mute is activated.

16. The apparatus of claim 15, further comprising:
a user interface in communication with the first mixer, the user interface comprising logic configured to receive data to establish the conference session and data indicative of the members of the group;
a communications interface in communication with the mixer and the user interface;
wherein the user interface logic is configured to establish a meeting identification for the conference session and a separate meeting identification for the virtual conference room;
wherein the communication interface distributes the separate meeting identification for the virtual conference room to group members; and
wherein the user interface is configured to distribute the identification for the conference session to users that are not members of the group.

17. A method, comprising:
creating a conference session having a plurality of locations;
defining a virtual group;
determining a subset of the plurality of locations where members of the virtual group are located;
receiving input media signals from the plurality of locations;
mixing and distributing input media signals from the plurality of locations to the subset responsive to a group mute; and
mixing input media signals from the plurality of locations not in the subset of the plurality of locations and distributing the mixed input media signals from the plurality of locations not in the subset of the plurality of locations to the plurality of locations not in the subset of the plurality of locations responsive to a group mute.

18. The method of claim 17, further comprising:
creating a first meeting identifier for the virtual group;
creating a second meeting identifier for at least one non-member of the virtual group;
distributing the first meeting identifier to the virtual group; and
distributing the second meeting identifier to the at least one non-member of the virtual group.

19. The method of claim 17, further comprising designating one member of the virtual group as a moderator controlling the group mute function.

20. The method of claim 19, further comprising:
receiving a group mute request from a member of the virtual group;
forwarding the group mute request to the moderator; and
implementing the group mute responsive to the moderator approving the group mute request.

21. An apparatus, comprising:
a device configured for receiving a plurality of input media signals from a plurality of locations for a conference session, the device comprising logic configured to determine how to mix the input media signals and to distribute input media signals to a plurality of outputs corresponding to the plurality of locations;
wherein the device is configured to communicate instructions on how to mix the input media signals to devices coupled to the plurality of outputs corresponding to the plurality of locations;
wherein the logic is configured to establish a virtual conference room for members of a group at a multiplicity of locations which are a subset of the plurality of locations; and
wherein the logic is responsive to receiving a group mute request from a member of the group to provide instructions to the plurality of locations that do not belong to the virtual conference room to ignore input media signals belonging to members of the group in the virtual conference room.

22. The apparatus of claim 21, wherein the mixer comprises a plurality of mixers.

23. The apparatus of claim 21, wherein the mixer is further responsive to receiving the group mute request to provide instructions to members of the virtual conference room to mix media signals from members of the group to the virtual conference room at a first setting and to distribute media signals from all other users to the virtual conference room at a second setting.
